(19) United States
(12) Patent Application Publication
(10) Pub. No.: US 2012/0016713 A1
(43) Pub. Date: Jan. 19, 2012

(54) Information Technology System Change Planning

(76) Inventors: Lawrence Wilcock, Wiltshire (GB); Nigel Edwards, Bristol (GB); Johannes Kirshnick, Bristol (GB); Sebastian Hagen, Pegnitz (DE)

(21) Appl. No.: 13/258,970

(22) PCT Filed: Oct. 15, 2009
(86) PCT No.: PCT/US2009/060919

§ 371 Date: Sep. 22, 2011

(51) Int. Cl. G06Q 10/00

(52) U.S. Cl. 705/7.27; 705/7.11; 705/348

(57) ABSTRACT

Systems and methods for information technology system change planning are described. In an information technology system change planning method in accordance with an embodiment, a change request is received on a network server (310). Domain objects and dependencies among domain objects are identified to form a model (320). Refinable tasks, atomic tasks, and state transitions are selected from a knowledge base based on the change request and the model (330), including dependencies. A workflow is created for implementing the change request using a processor (340). The workflow can be based on the model and may include a combination of selected refinable tasks, atomic tasks, and state transitions used to implement the change request.

### BACKGROUND

Businesses and enterprises can use software and services to help manage, integrate, update, change, and process business information, business interactions, software systems, etc. across a range of business processes. Recent endeavors to manage business systems and information have involved enabling information technology infrastructure in a general framework to support dynamic business activities. These management endeavors have involved the dynamic generation and control of processes which includes the composition of steps or tasks involved in achieving a business goal from conception to execution and termination.

The aggregation of steps that comprise a business process from the starting step to the completion of a business goal can be represented by a workflow. A challenge with business processes can be that a specific workflow path that comprises an end-to-end process cannot always be scripted or predicted in advance. Even where the process can be scripted end-to-end in advance, such scripting can be time-consuming and costly. Enterprises are increasingly adopting a model where projects and products are disaggregated and operating within a distributed computing environment. Such environments may include cloud computing networks, Internet hubs, private networks, etc. Managing business processes in a distributed network can place challenges on the business controls, business process software and IT infrastructure.

As a result, many enterprises and organizations have moved toward the automation of business processes using Workflow Management Systems (WFMSs). One of the fundamental assumptions in current WFMS is that workflow schemas (i.e. tasks, control flow and data flow) are predefined. In order to automate business processes workflow, designers need to understand business processes and use workflow modeling tools to define workflow schemas. When an end user wants to execute a business process, the end user creates a workflow instance by selecting a workflow schema and provides the necessary input data. WFMS executes the workflow instance and returns the results to the end user. One weakness of predefined workflow schemas is a lack of flexibility to cope with changing environments, including changes in applications, technology, policies, organization, etc. As such, predefined workflow schemas can become increasingly impractical for many enterprises. Businesses therefore desire the ability to efficiently make changes to or update systems in a network environment in a flexible manner that can provide a suitable workflow path.

### BRIEF DESCRIPTION OF THE DRAWINGS

FIG. 1 is a block diagram of an information technology system change planning system in accordance with an embodiment;

FIG. 2 is a block diagram showing domain objects, dependencies between the domain objects, and a workflow for implementing a change request, in accordance with an embodiment;

FIG. 3 is a block diagram of a system for information technology system change planning utilizing behavior, task, and entity management units, in accordance with an embodiment; and

FIG. 4 is a flow diagram of a method for information technology system change planning in accordance with an embodiment.

### DETAILED DESCRIPTION OF EXAMPLE EMBODIMENT(S)

Reference will now be made to the exemplary embodiments illustrated, and specific language will be used herein to describe the same. It will nevertheless be understood that no limitation of the scope of the information technology system change planning as described herein is thereby intended. Additional features and advantages will be apparent from the detailed description which follows, taken in conjunction with the accompanying drawings, which together illustrate, by way of example, features of the information technology system change planning systems and methods.

In describing and claiming the present invention, the following terminology will be used in accordance with the definitions set forth below.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, “information technology” (IT) is used to refer to the study, design, development, implementation, support or management of computer-based information systems, and may relate to software applications and computer hardware. IT can involve the use of electronic computers and computer software to convert, store, protect, process, transmit, and securely retrieve information. An IT architecture can be an integrated framework for acquiring and evolving IT to achieve strategic goals and may include both logical and technical components. Logical components may include mission, functional and information requirements, system configurations, and information flows. Technical components may include IT standards and rules that will be used to implement the logical architecture.

Described herein are systems and methods for change planning for hardware and software managed in large data centers. The change planning systems and methods can overcome deficiencies found in prior art. In one aspect, the change planning systems can make change management policies easier to create, read, maintain, and plan more cost-effectively. Prior art systems have not been able to combine state-based descriptions of systems with workflow descriptions which can be more task-based, rather than state-based.

Workflow approaches can describe a system as a set of sequenced steps, each of which can often be decomposed into one or more smaller sub-steps. For example, to perform a particular large task, any number of smaller tasks may be performed to accomplish the large task. In certain situations, a sequence of smaller tasks, such as an ordered sequence of tasks or sequentially ordered sequence of tasks, may be performed to accomplish the large task, and in other situations the smaller tasks may be performed in any non-particular order or sequence.

State-based approaches often describe systems or components of systems as state machines having a finite set of states and transitions between states. State-based approaches may also describe dependencies between states. For example, a software component may not be able to transition to an “installed” state unless the machine on which the software is hosted is in an “on” state.

As an example demonstrating the differences between workflow and state-based approaches, an administrator may wish to apply a software patch to update a database. Application of the patch may involve stopping the database and any components dependent on the database, performing the update, carrying out a sequence of tests to ensure the patch was properly applied, and then restarting the system. In such situations, a solely state-based or workflow-based planning approach can be insufficient. State-based approaches cannot capture an importance of sequenced steps (e.g. update the database and then perform functional and performance tests). Workflow-based approaches often may have difficulty in capturing state-based lifecycles and dependencies. For example, before an update to the database can be performed, the load-balancer, web-server, application server and database should be transitioned to an “installed” (not running) state, then restarted and transitioned to a “running” state.

To overcome deficiencies of prior systems, information technology system change planning systems and methods are described herein. In an embodiment of an information technology system change planning method, a change request is received on a network server. The change request can come from a user or from a device in the network. Domain objects and dependencies among domain objects are identified to form an actual or simulated model. Refinable tasks, atomic tasks, and state transitions are selected from a knowledge base based on the change request and the model, including dependencies. A workflow is created for implementing the change request using a processor. The workflow can be based on the model and may include a combination of selected refinable tasks, atomic tasks, and state transitions used to implement the change request.

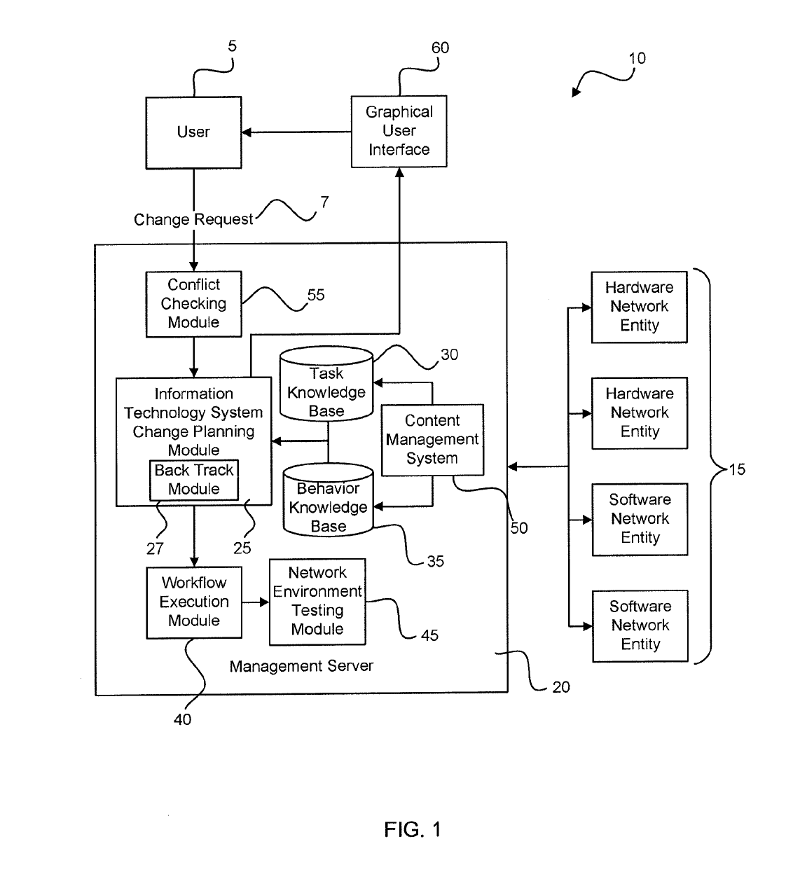

As illustrated in FIG. 1, a system is shown, indicated generally at 10, for information technology system change planning in an example implementation in accordance with an embodiment. A plurality of networked devices 15 can be in communication with a management server 20. The plurality of networked devices can be a plurality of domain objects. The domain objects can include hardware and software network entities, including, but not limited to servers, workstations, routers, switches, software applications, management programs, etc.

A change planning module 25 on the management server 20 can identify the domain objects 15 in communication with the management server. The change planning module can use the identification of the domain objects to create an actual or simulated model of the system. In one aspect, the model may comprise the various hardware and software entities existing on the network. The simulated model may be simulated on a virtual machine. The virtual machine may be on the management server or on a different server. The change planning module can be configured to create a workflow based on the model to implement a change request 7. In other words, the change planning module can custom design a workflow to implement a change request based on configurations, dependencies, relationships, etc. among and between the domain objects. The workflow can be a composite workflow comprising both tasks and state changes.

A task knowledge base 30 can be accessible by the change planning module 25. The task knowledge base can include rules for completing actual or simulated refinable or decomposable tasks. The task knowledge base may also include rules for completing actual or simulated atomic (e.g., non-refinable or non-decomposable) tasks. The tasks in the task knowledge base can be executed in a workflow implementation to carry out the change request 7. The task knowledge base may be a database, table, or any other form of information repository. The task knowledge base may be stored on a computer readable medium. The task knowledge base can be stored on the management server or on a computer readable medium in communication with the management server.

A behavior knowledge base 35 can also be accessible by the change planning module 25. The behavior knowledge base can include rules for performing actual or simulated state transitions of the domain objects 15. The state transition rules in the behavior knowledge base can be executed in workflow implementation to carry out the change request 7. The behavior knowledge base and the task knowledge base can be separate knowledge bases or may comprise a single knowledge base having behavior (state transition) and task rules, including rules for dependencies. The behavior knowledge base may be a database, table, or any other form of information repository. The behavior knowledge base may be stored on a computer readable medium. The behavior knowledge base can be stored on the management server or on a computer readable medium in communication with the management server.

Task rules and state transition rules within respective knowledge bases can include rules for managing domain object dependencies. For example and as has been described above, a database may need to be transitioned from a running state to an installed (not running) state before a server on which the database is running can be transitioned to an off-line state. Also, backing up or otherwise storing current database information before transitioning the database to a non-running state can be desirable. To accomplish such objectives, task rules and state transition rules, as well as dependency rules, can be called from other task rules, state rules, and dependency rules from either of the task knowledge base and the behavior knowledge base. The dependency rules can be preconditions for the task rules and the state transition rules. The dependency rules may be task rules and/or state transition rules and can be used to account for dependencies among domain objects. In one aspect, the task knowledge base and the behavior knowledge base can be expressed in a Groovy-based domain specific language. Groovy is an object-oriented programming language for the Java® platform as an alternative to the Java® programming language. Groovy can be used as a scripting language for the Java® platform.

The system may further include applicability conditions for task rules and state transition rules. The applicability conditions can be associated with a rule and allow the change planning module 25 to select a subset of the rules in a respective knowledge base for creating a plan to satisfy the change request. The applicability conditions can reference the model to test for attributes of object instances in the model or to specify the class of model object for which the rules may apply, or to both test the model for attributes of object instances in the model and to specify the class of model object for which the rules may apply. This can help facilitate modularity of the rules and the rule selection process.

The system 10 can further include a workflow execution module 40 on the management server 20. The workflow execution module can be configured to execute the workflow on the simulated model in order to plan for how to best carry out the change request, or the workflow can be executed on an actual model of the system. A system administrator may desire to test the workflow on a simulated model before implementing the workflow on the actual network objects so that any issues encountered during or after implementation can be properly addressed without causing problems with the production systems. Execution of the workflow on the simulated model can lead to fewer and shorter system down times and can allow streamlining of the workflow before implementation. Execution of a workflow on the simulated model can enable testing the workflow and the system without risking any damage, data loss, etc. to the actual system. Execution of the workflow on the actual model actually implements the workflow on real entities in the system.

To test the simulated model after execution of the workflow on the simulated model, a network environment testing module 45 is provided. The network environment testing module can test the simulated model after execution of the workflow to determine workflow effectiveness. Workflow effectiveness can be any type of metric for determining whether the workflow accomplished the requested goals in the change request and whether any issues were encountered during or after execution of the workflow which a system administrator may wish to address. Workflow effectiveness can also include issues with efficiency of implementation and any other factor which may be desirable by an administrator in monitoring or analyzing a system before, during, or after a workflow execution, as well as monitoring or analyzing the actual workflow and execution thereof.

In one aspect, the system 10 may include a content management system 50. The content management system can be configured to manage the task knowledge base 30 and the behavior knowledge base 35. For example, as new domain objects are introduced to the network, or existing domain objects are removed from the network, then task, transition, and dependency rules can be added, removed, or updated to reflect current network entities, relationships, dependencies, etc. The content management system can be an automated system or may be user-controlled, or may be a combination automated and user-controlled system. In one aspect, the content management system can be in communication with network entities to exchange information about status, identity, etc. In a further aspect, the content management system can be managed by or through one or more network entities.

The change planning module 25 can further include a back track module 27. The back track module can be configured to track back through earlier workflow stages when a construction of a complete workflow to achieve the change request fails. A workflow failure may result when a selected rule has limited later rule options to a subset from which the change request cannot be implemented. For example, to implement a change request 7 from a user 5, any number of possible alternative task rules and state-transition rules may be available. The change planning module may select one of the various alternatives in creating a workflow. Selection of a rule can be based on any variety of factors. For example, a first rule may be selected over a second rule if the first rule has been successfully used in the past where the second rule has not. One having skill in the art will recognize any number of possible factors which may be used in selecting one rule over another.

Once the change planning module has selected a rule, additional rules can also be added to the workflow or the workflow can be tested. If after selecting a rule the change request cannot be implemented because the selected rule has limited later rule options to a subset from which the change request cannot be implemented, the change planning module can use the back track module to track back through stages of the workflow to the selected rule which caused the limitation or error and select a different rule from which to proceed. In another aspect, if after selecting a rule the change request can be implemented but causes a problem during or after execution of the change request, the change planning module can likewise use the back track module to track back through workflow stages to select a different alternative rule for a rule which led to the problem. In one aspect, the selected rule may be a refinable or decomposable task. This refinable or decomposable task may in turn be a refinement of a different rule or task. A conflict checking module 55 can be included in the system 10. The conflict checking module can be in communication with the change planning module 25. The conflict checking module can be a part of the change planning module or may be a separate entity. The conflict checking module can be configured to check for conflicts between change requests. For example, multiple change requests 7 may be received on the management server 20. The conflict checking module can be used to determine the priority of the change requests or can be used to determine any possible conflicting workflow issues in implementing the requests. For example, one change request may impact states, transitions, functionality, etc. of a domain object 15. This impact may alter which rules can or should be selected from the task and behavior knowledge bases 30, 35 to implement a second change request. Additionally, conflicting change requests may result in priority being assigned to a senior or more important change request while a junior or lesser important change request waits for the senior or more important change request to be completed. In one aspect, conflict management can be managed by the conflict checking module or the change planning module by planning for an additional dependency in the model when a conflict is discovered.

In some instances, the system 10 may be unable to resolve a conflict. The system can include a graphical user interface 60 which can be displayed on a display for the user 5. The user can receive notification of the conflict and choose various options, such as to override the conflict, determine a resolution for the conflict, etc. The graphical user interface can be used to display system-resolved conflicts and the resolution of the system-resolved conflicts. The graphical user interface can also be used to provide any variety of data and information to the user. For example, the graphical user interface can be configured to display the work flow as a tree of tasks and transitions, including constraints among the tasks and transitions. A user may then be able to manipulate the tree, such as by expanding, compressing, or altering nodes, of the tree, or tasks or transitions used in the workflow.

Planning IT changes using a system as has been described can enable both hierarchical task refinement and state-based descriptions of systems to coexist and to refer to one another in a natural way. The approach can include a policy description language used to create a planning knowledge base, and an associated planning method to be processed by a processor. The knowledge bases can be currently expressed in a Groovy-based Domain Specific Language (DSL). Groovy can be a convenient language to represent not only the policies that describe behavior of domain entities, but also model the entities themselves. As such, Groovy can enable a single, integrated language environment.

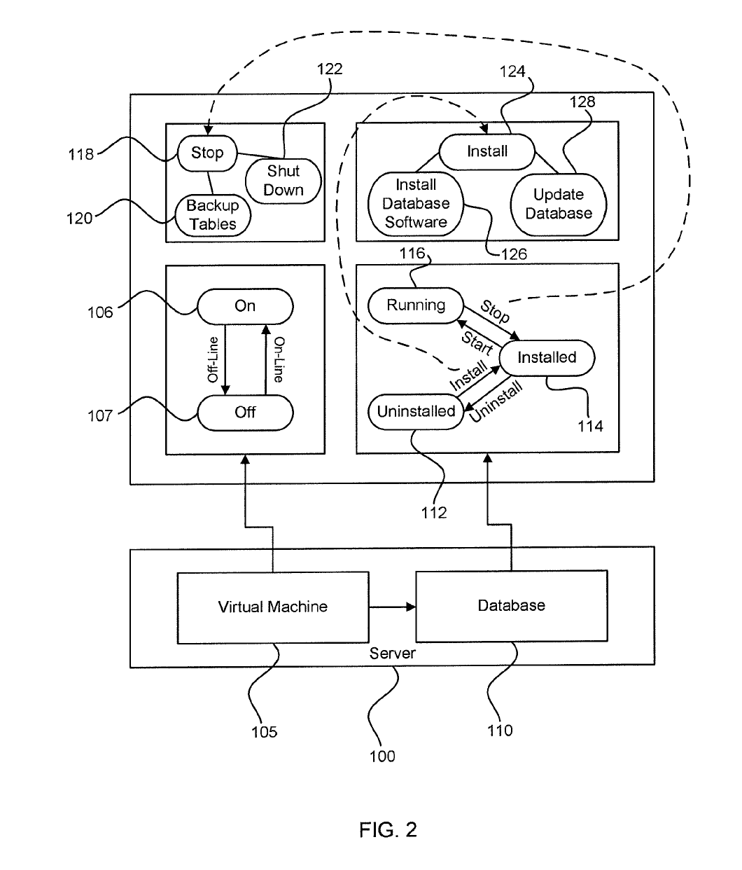

Referring to FIG. 2, a block diagram shows domain objects, dependencies between the domain objects, and a workflow for implementing a change request, in accordance with an embodiment. FIG. 2 represents a simplified domain model for a database software component 110 and an associated virtual machine 105. The virtual machine and database may be part of or running on a server 100 or group of servers. The database may be dependent on the virtual machine. For example, the database may only be able to run when the virtual machine is in an “on” state 106 and not in an “off” state 107. In a more detailed aspect, the database may be in an “installed” 114, “running” 116, or “uninstalled” 112 state when the virtual machine is in an “on” state. Accordingly, the database may be in an “uninstalled” state 112 or an “installed” state 114, but not a “running” state 116 when the virtual machine is in the “off” state. The database in this example can share a same generic set of states and transitions as other software components in the domain. Use of generic states, transitions, and other rules can maximize reusability of rules in the knowledge bases for various different uses and applications. Likewise task and dependency rules can be applied to generic software or hardware network entities maximizing reusability of task and dependency rules as well.

Generic behavior rules used in implementing change requests, such as for instigating a transition can be easily refined for the database with specific implementations. FIG. 2 shows two such example implementations. One rule can be used to stop the database (e.g., change the state of the database from “running” to “installed”), and another rule can be used to install the database (e.g., install a patch for the database, update the database, etc.). State transition rules can be found in the behavior knowledge base. The state-transition rule to stop the database can invoke a refinable “stop” task 118. The “stop” task may comprise multiple atomic tasks, such as to backup tables 120 in the database and then to shut down 122 the database. The state transition rule to install the database can invoke a refinable “install” task 124. The “install” task shown here further includes multiple atomic tasks to install database software 126 and to update the database 128. The “stop” and “install” tasks shown in the figure can represent task decomposition methods for “stop” and “install” tasks and may include rules from in the task knowledge base. In some instances, atomic tasks within a refinable task can be performed in any order, and in some instances the atomic tasks are configured to be performed in a predetermined order. For example, with the “stop” task, an administrator would want the tables backed up before the database is shut down. With the “install” task, software installation may be prioritized before database updating. In other examples, ordering of tasks may not be as important and the tasks may be performed in any order. FIG. 2 shows how a state-based rule can be used to reference a task rule to specify an entity-specific decomposition of a change request implementation. State Transition Systems (STSs) (e.g., the entity states and transitions between those states), such as an STS for the virtual machine and the database can implement rules found in the behavior knowledge base. The STS can define the tasks and rules for causing transitions between states.

Although not shown in FIG. 2, one or more refinable or atomic task rules could equally have referenced transitions to specific states. For example, in FIG. 2, the shut down task 122 may be refined to a state transition of the database from the “running” state 116 to the “installed” state 114. In another example and considering a task-based workflow, an alternative “install” task can include sub-tasks for stopping and uninstalling the database which may include calls for state transitions of the database from “running” to “installed” and from “installed” to “uninstalled”. The “install” task can then proceed to install database software and update the database and may include state transitions for the database from “uninstalled” to “installed” and/or “running”.

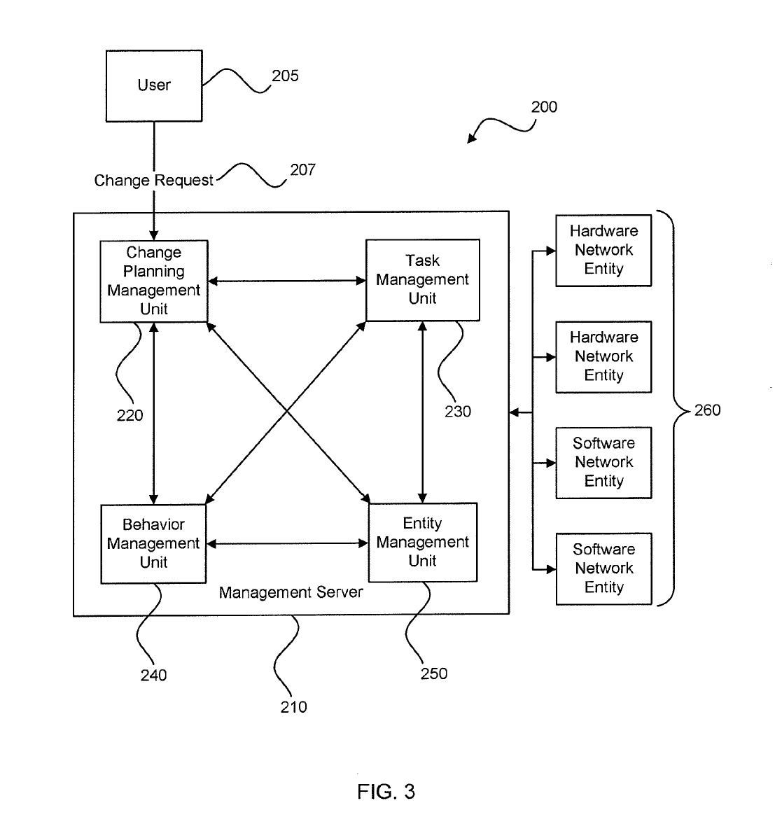

Referring now to FIG. 3, a system 200 is shown for information technology system change planning on three levels, including a behavior level, a task level, and an entity level, in accordance with an embodiment.

The task level can allow best practice policies for workflow and hierarchical task decomposition to be described. Methods can describe the refinement of non-atomic change requests into child tasks. Child tasks can be specified to run either sequentially or in parallel. Operators can describe changes implemented by non-refinable atomic change requests that affect the real system and/or the simulated model. Atomic change requests may comprise leaf nodes of a planning tree. Operators can call Groovy methods on the model. Thus, effects of rules do not necessarily need to be specified within the Domain Specific Language (DSL) describing the knowledge base. The knowledge base becomes more readable when complex change behavior is hidden behind method calls.

The behavior level can describe lifecycle states of domain entities as State Transition Systems (STS) (e.g., the entity states and transitions between those states). Dependencies can specify pre-conditions for state transitions (e.g., a domain entity must be brought into a specified state before a transition is allowed). States of domain objects can be automatically kept updated by all implemented methods.

The entity level can be an object oriented domain model describing characteristics of hardware and software entities hosted in a data center, and the relationships of the entities. The object oriented model can also includes the schema of resulting change request objects generated by a plan or workflow. The model can be easily adapted to account for physical infrastructure in a network. For example, classes for physical machines, switches, network drives, and Ethernet cables with suitable references to other domain objects can be added.

The task level, behavior level, and entity level can all be managed by respective task 230, behavior 240, and entity 250 management units. These units may reside on or be in communication with a management server 210. The task, behavior, and entity management units may also be in communication with a change planning management unit 220 on the management server. The change planning management unit can receive a change request 207 from a user 205 or from another network device and plan for the change through communicating with the task, behavior, and entity management units.

Operation of the task, behavior, and entity management units on the task, behavior, and entity levels can be understood by the foregoing discussion and by reference to FIGS. 2 and 3. The virtual machine 105 and the database 110 can be domain objects 260 on the entity level. The virtual machine and the database software may each include state transition systems. The state transition system for the virtual machine can be used to transition the virtual machine between an “on” and an “off” state. The state transition system for the database software can be used to transition the database software between “running”, “installed”, and “uninstalled” states. The state transition systems can be on a behavior level 240 of the system. The “stop” and “install” refinable tasks can be methods on the task level 230. A knowledge base may comprise rules, such as for managing task and behavior levels. In one aspect, a rule for one level can refer to other rules either in the same level or across levels,

Using the change planning systems and methods herein can enable switching from hierarchical refinement planning to planning according to states of domain objects. For example, a change request to patch a domain object can be decomposed into a state-changing change request to stop the target, a non-atomic change request to further refine the patching process, and a state-changing change request to start the target again. The ability to change between the two abstractions can make the approach flexible and easy to adapt.

In the change planning approach described herein, change planning can proceed by describing only those dependencies directly affecting domain objects. For example, the database needs a pre-dependency to stop the Apache servers when the database is stopped. An Apache server can also hold a pre-dependency linked to a stop transition to stop a load balancer. This stop dependency may be valid only if the Apache server is the last object running in the system. Thus, the system can exploit transitivity over dependencies.

Because dependency and behavior information described in state-transition systems can be separated from the refinement strategies described by methods and operators, task and behavior knowledge bases can even be written by different knowledge base engineers without encountering problems in implementing the system. For example, one knowledge base may be written by an expert in the management (installation, starting, stopping) of applications and another knowledge base may be written by an expert in best practice change management workflows.

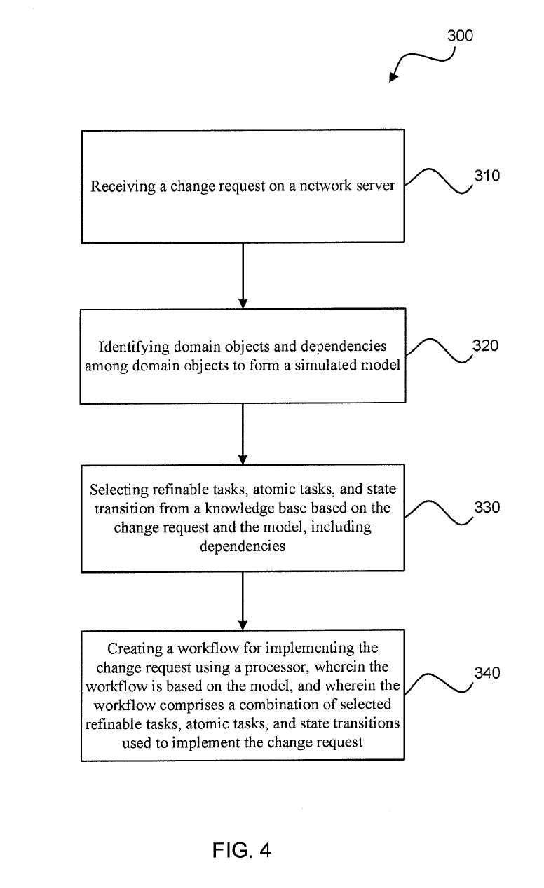

Referring to FIG. 4, a method 300 is shown for information technology system change planning in accordance with an embodiment. A change request can be received 310 on a network server. Domain objects and dependencies among domain objects can be identified 320 using a change planning module to form a simulated model. The simulated model can be of the entire network or of objects on the network, or may be a model of a specified set of objects. Refinable tasks, atomic tasks, and state transitions can be selected 330 from a knowledge base based on the change request and the model, including dependencies. A workflow for implementing the change request can be created 340 by the change planning module using a processor. The workflow can be based on the model and may comprise a combination of selected refinable tasks, atomic tasks, and state transitions used to implement the change request.

In accordance with further aspects, the method can include executing the workflow on the simulated model and testing the simulated model to determine workflow effectiveness. The refinable tasks, atomic tasks, and state transitions can be rules within the knowledge base, and creating a workflow can include selecting the rules such that the refinable tasks, atomic tasks, and state transitions call other refinable tasks, atomic tasks, and state transitions from the knowledge base to implement the change request. Creating the workflow can comprise using object oriented notation, such as Groovy scripts, to describe the workflow. Creating the workflow may also comprise creating a workflow depending on rules for parallel versus sequential refinable tasks, atomic tasks, and state transitions. Creating the workflow may also comprise creating a state-based workflow, wherein rules for refinable tasks, atomic tasks, and state transitions are used in the workflow to achieve a state specified in the change request. Alternatively, creating the workflow may comprise creating a task-based workflow, wherein rules for refinable tasks, atomic tasks, and state transitions are used in the workflow to accomplish a refinable task specified in the change request.

The method can take various inputs, such as: (1) An instance of the model; (2) the DSL describing STSs, methods, operators, and dependencies; and (3) a high-level change request (atomic, non-atomic, or state-changing) to plan for. In one example, the model instance may consist of a load balancer, one or more Apache servers, and a database, all of which may be in a Started state. On processing the input data, a change request can be put into a queue for the planning module. The method can involve looping over the change request queue. If the queue is empty, the planning module may wait until a change request is received. When rules are selected for implementing a change request the rules can be pushed onto a stack storing the order of rules used to implement the change request being planned for. The stack can be used during back tracking to find a previously planned rule with another decomposition alternative. In addition, the model over which the change plan is being made can be serialized to be restored if the algorithm back tracks to a particular rule. Because the change request queue and/or the stack may need to be restored on back tracking, the change request queue and/or the stack can be backed up. If planning for the change request fails, the back track method looks through the stack until a rule is found that has another possible decomposition. If none is found, planning may fail and an administrator can be notified.

To plan for a change request, the change request may first be checked to determine whether the change request is a state-changing change request, which could affect priority of the change request in the queue based on other pending change requests and states used to implement those pending change requests. The planning module can use a conflict checking module to check for conflicts and attempt to resolve any discovered conflicts. A non-atomic first change request may be in conflict with a second change request if the second change request happens in parallel to the first change request, has a same target, and/or is already part of the decomposition tree. Where there are no parallel change requests, a non-state-changing change request may be conflict free. If there is a parallel change request with a same target, the planning module may add an additional temporal dependency to resolve the conflict.

As the planning module plans for the change request for the first time, all possible decompositions can be computed using a processor. To compute all decompositions, the planning module can iterate over all methods applying their precondition to the target of the change request to determine whether the method is applicable. For applicable methods, all possible decompositions can be computed. Having computed all decompositions for a refinable task or rule, the system can query the knowledge base for decompositions for other tasks or rules until all options have been examined. In one aspect, the system may examine all alternatives before testing a workflow. In another aspect, the system may test the workflow once a viable alternative has been found, which may be before all available alternatives have been examined. The method may further include executing the workflow and testing the workflow on a simulated model and/or executing and testing the workflow in a real network environment as has been described herein.

The automated change planning described herein can natively support planning based on workflows, task-refinement, and state-based constraints. All of these abstractions can be inherent to the domain of IT change request planning and be clearly separated by the described approach. The described systems and methods have several advantages over previously existing approaches including increased readability and maintainability of the workflows, knowledge bases, rules, and systems. Additionally, the systems and methods can decouple the dependency specification from the state-transition system specification, enabling specification of domain objects with a same lifecycle but with different dependency behavior in a reusable way. This can increase the usability of knowledge bases.

Because the systems and methods herein enable separation of lifecycle behavior, state constraints, and task refinement strategies, knowledge bases can be easier and cheaper to maintain, adapt, and extend. The ease and cost can be particularly significant in a cloud computing context because of the complexity and dynamic nature of applications in these environments.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A method for information technology system change management, comprising:
receiving a change request on a network server (310);
identifying domain objects and relationships among domain objects to form a model (320);
selecting tasks and state transitions from a knowledge base based on the change request and the model, including dependencies (330); and
creating a workflow for implementing the change request using a processor, wherein the workflow is based on the model, and wherein the workflow comprises a combination of selected refinable tasks, atomic tasks, and state transitions used to implement the change request (340);
wherein the tasks and the state transitions are rules within the knowledge base, and wherein creating a workflow further comprises selecting the rules such that the refinable tasks, atomic tasks, and state transitions call other refinable tasks, atomic tasks, and state transitions from the knowledge base to implement the change request.

2. A method as in claim 1, further comprising executing the workflow on a simulated version of the model.

3. A method as in claim 2, further comprising testing the simulated model to determine workflow effectiveness.

4. A method as in claim 1, wherein the model is an actual model representing actual domain objects and dependencies in a system, the method further comprising executing the workflow on the actual model.

5. A method as in claim 1, wherein creating the workflow further comprises creating a workflow depending on rules for parallel and sequential refinable tasks, atomic tasks, and state transitions.

6. A method as in claim 1, wherein creating the workflow further comprises creating a state-based workflow, wherein rules for refinable tasks, atomic tasks, and state transitions are used in the workflow to achieve a state specified in the change request.

7. A method as in claim 1, wherein creating the workflow further comprises creating a task-based workflow, wherein rules for refinable tasks, atomic tasks, and state transitions are used in the workflow to accomplish a refinable task specified in the change request.

8. A method as in claim 1, wherein selecting refinable tasks, atomic tasks, and state transitions from the knowledge base further comprises selecting refinable tasks and atomic tasks from a task knowledge base and selecting state transitions from behavior knowledge base which is separate from the task knowledge base.

9. An information technology system change planning system, comprising:
a plurality of networked devices (15) in communication with a management server, the plurality of networked devices comprising a plurality of domain objects;
an change planning module (25) on the management server configured to identify the domain objects to create a model, and further configured to create a workflow based on the model to implement a change request;
a task knowledge base (30) accessible by the change planning module, the task knowledge base comprising a plurality of rules for completing refinable and atomic tasks executable for change request implementation; and
a behavior knowledge base (35) accessible by the change planning module, the behavior knowledge base comprising a plurality of rules for state transitions of the domain objects executable for change request implementation, wherein:
task and state transition rules within respective knowledge bases include rules for managing domain object dependencies; and
the task rules and the state transition rules, as well as dependency rules, can be called from other task rules, state rules, and dependency rules from either of the task knowledge base and the behavior knowledge base, the dependency rules comprising preconditions for the task rules and the state transition rules.

10. A system as in claim 9, wherein the model is a simulated model and further comprising a workflow execution module on the management server configured to execute the workflow on the simulated model.

11. A system as in claim 10, further comprising a network environment testing module configured to testing the simulated model after execution of the workflow to determine workflow effectiveness.

12. A system as in claim 9, wherein the model is an actual model and further comprising a workflow execution module on the management server configured to execute the workflow on the actual model.

13. A system as in claim 9, further comprising a content management system configured to manage the task knowledge base and the behavior knowledge base.

14. A system as in claim 9, wherein the change planning module further comprises a back track module configured to track back through workflow stages to a refinable task a second refinement alternative when the workflow fails using a first alternative.

15. A system as in claim 9, further comprising a conflict checking module configured to check for conflicts between the change request and a second change request.
